(19) United States
(12) Patent Application Publication
(10) Pub. No.: US 2026/0099311 A1
(43) Pub. Date: Apr. 9, 2026

(54) CLUSTER EXPANSION USING A FLEXIBLE READY NODE AND ENHANCED JOIN PROCESS

(71) Applicant: Dell Products L.P., Round Rock, TX (US)

(72) Inventors: Steven Soumpholphakdy, Austin, TX (US); Anton Rang, Houlton, WI (US); David T. Leimbach, Everett, WA (US)

(21) Appl. No.: 18/909,499

(22) Filed: Oct. 8, 2024

(51) Int. Cl. G06F 8/61

(52) U.S. Cl. CPC G06F 8/63

(57) ABSTRACT

A method facilitating cluster expansion using a flexible ready node and enhanced join process includes determining a compatibility between a first operating system of a first node device and a second operating system of a second node device in response to the first node device receiving a request by the second node device to join a cluster in which the first node device operates; in response to determining that the second operating system does not have the compatibility with the first operating system, causing the second node device to install an operating system image, the operating system image being of an operating system version that is compatible with the first operating system; and facilitating merging of the second node device into the cluster in response to determining that the second node device has successfully installed, and booted from, the operating system image.

### BACKGROUND

As computing technology advances, new operating systems, software applications, and the like are being developed to enhance user experience, provide new features, improve security, and provide other benefits. As these operating systems and/or other software become available, it is desirable to provide techniques to facilitate interoperability between computing devices in a computing cluster having different configurations, particularly in cases where a computing device is to be added to a cluster that includes devices that do not match the configuration of the device to be added.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include determining compatibility between a first operating system, used by a first computing device, with a second operating system, used by a second computing device, in response to receiving a request to merge the second computing device into a cluster in which the first computing device operates. The operations can also include, in response to determining that the second operating system is incompatible with the first operating system, causing the second computing device to install an operating system image, the operating system image being of an operating system version that is compatible with the first operating system. The operations can further include merging the second computing device into the cluster in response to determining that the second computing device has successfully installed, and booted from, the operating system image.

In another implementation, a method is described herein. The method can include determining, by a first node device including at least one processor, a compatibility between a first operating system of the first node device and a second operating system of a second node device in response to the first node device receiving a request by the second node device to join a cluster in which the first node device operates. The method can further include, in response to determining that the second operating system does not have the compatibility with the first operating system, causing, by the first node device, the second node device to install an operating system image, the operating system image being of an operating system version that is compatible with the first operating system. The method can additionally include facilitating, by the first node device, merging of the second node device into the cluster in response to determining that the second node device has successfully installed, and booted from, the operating system image.

In an additional implementation, a non-transitory machine-readable medium is described herein that can include instructions that, when executed by at least one processor, facilitate performance of operations. The operations can include determining whether a first operating system, used by a first node device operating in a computing cluster, is incompatible with a second operating system used by a second node device in response to receiving a request to merge the second node device into the computing cluster; in response to determining that the first operating system is incompatible with the second operating system, causing an operating system image to be installed on the second node device, the operating system image being of an operating system version that is compatible with the first operating system; and initiating merging the second node device into the computing cluster in response to determining that the second node device has successfully installed, and booted from, the operating system image.

### DESCRIPTION OF DRAWINGS

Various non-limiting embodiments of the subject disclosure are described with reference to the following figures, wherein like reference numerals refer to like parts throughout unless otherwise specified.

FIGS. 1-6 are block diagrams of respective systems that facilitate cluster expansion using a flexible ready node and enhanced join process in accordance with various implementations described herein.

FIGS. 7-11 are diagrams illustrating example operations that can be performed to add a node device to a computing cluster in accordance with various implementations described herein.

FIGS. 12-13 are diagrams illustrating respective procedures that can be utilized in connection with one or more implementations described herein.

FIGS. 14-15 are flow diagrams of respective methods that facilitate cluster expansion using a flexible ready node and enhanced join process in accordance with various implementations described herein.

FIG. 16 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As advancements to the software framework of computing devices (e.g., in the form of updated operating systems, file systems, software applications, etc.) become available, it is desirable to provide techniques to facilitate formation of a computing cluster between different devices that may have different operating systems or other software configurations. For instance, after a new operating system is made available, computing clusters based on the new operating system will start being used. In the event that the new operating system is designed to be compatible with previous operating systems, it is desirable to provide a mechanism to be able to add nodes using the older operating system to clusters associated with the newer operating system.

Additionally, although compatibility can be provided between different operating systems, if a cluster being joined contains nodes that are all based on a newer operating system, it is desirable to provide a way to convert a joining node to that newer operating system if the node is not already running it. Because a joining node cannot be guaranteed to be running a given version of code, it is also desirable to have a way for that node to convert to a version of code that is compatible with the cluster, convert the node to utilize the operating system used by the cluster, and then finally have it join the cluster. Conversely, there are also use cases for joining nodes running a newer operating system to a cluster that runs an older operating system, and similar techniques for these use cases are also desirable.

To the furtherance of the above and/or related ends, implementations described herein can provide a process to detect that a node attempting to join a cluster has an operating system that is incompatible with that of the cluster and, as a result, orchestrate a regrade the joining node to an operating system image that is compatible with the cluster operating system. Additionally, implementations described herein can then facilitate converting the joining node to a state that resembles a factory-ready node running on the operating system used by the cluster. Characteristics of a “factory-ready node,” also referred to herein as simply a “ready node,” are described in further detail below.

By utilizing one or more implementations as described herein, upgrades to the operating systems and/or other software components of a computing device joining a computing cluster can be performed using automated processes that can operate at a higher level of complexity than is possible to be performed manually by a human, e.g., due to the number of calculations and/or other operations performed in parallel, the number of joining devices that can be processed simultaneously, and/or other factors. Additionally, implementations described herein can facilitate automation of highly technical tasks that are inherently and/or inextricably tied to computer technology and cannot be implemented outside of a computing environment, such as tasks associated with disk partition management, data migration, software configuration and installation, or other aspects of computing system management. As a result, by utilizing one or more automated techniques facilitated by implementations described herein, an end user can be given the ability to perform system upgrade and/or cluster management tasks for an associated computing system, e.g., by simply pressing a button on a user interface, inputting a simple command, or performing other comparable actions, even if that user lacks the requisite knowledge to perform those tasks manually. Similarly, if problems are encountered during this process, implementations described herein can facilitate automated techniques that can give an end user the ability to reverse the process by performing comparable actions that do not require specific knowledge on the part of the user of the upgrade process and/or the error(s) encountered during that process.

With regard to the following description, it is noted that any references to specific operating systems, software applications, or the like, are made merely by way of example and are not intended to limit the scope of the description or the claimed subject matter unless explicitly stated otherwise. For instance, while various examples provided herein relate to examples involving conversion of a Berkeley Software Distribution (BSD)-based node to a Linux-based node, or vice versa, it is noted that similar concepts to those described herein could also be applied to facilitate conversion to and/or from other operating system types, either in addition to or in place of the named operating system types.

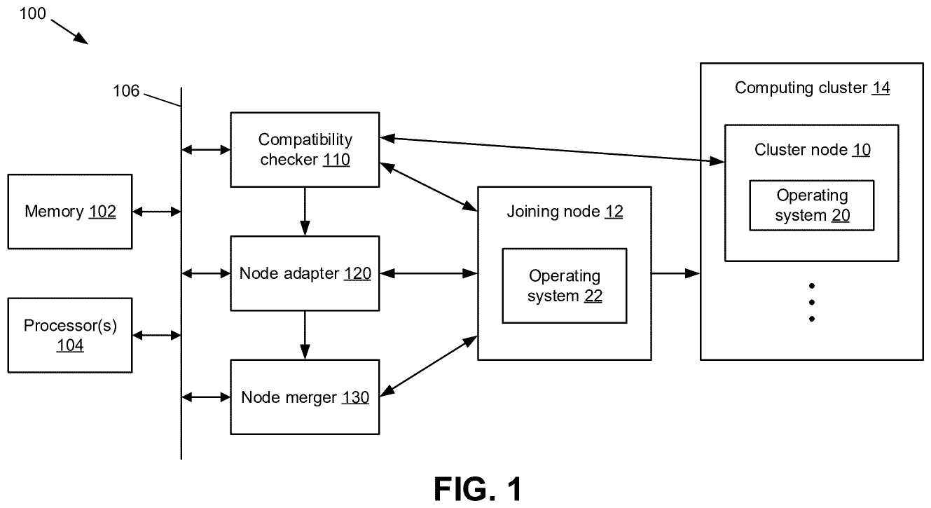

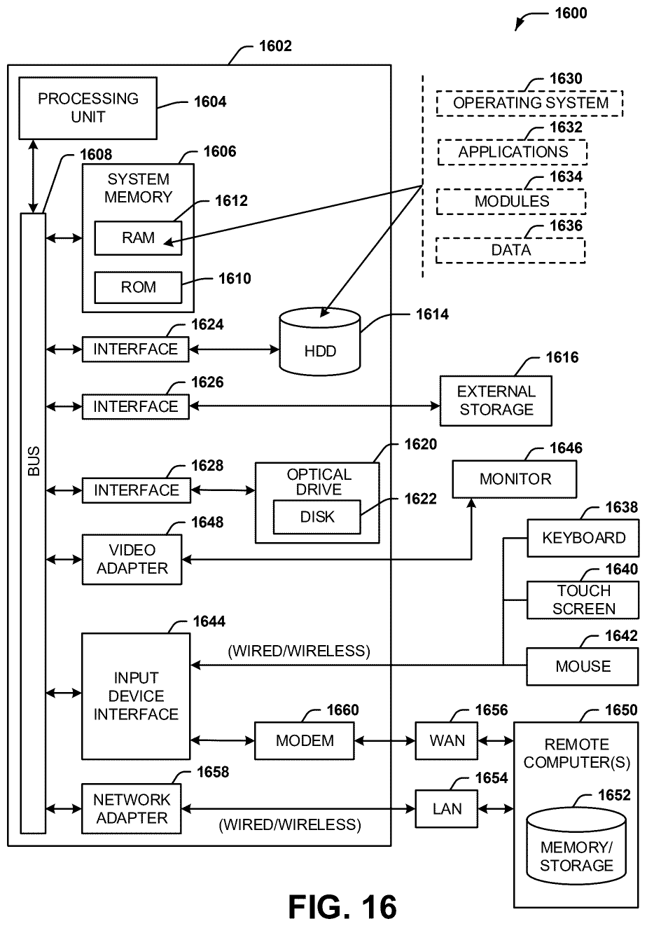

With reference now to the drawings, FIG. 1 illustrates a block diagram of a system 100 that facilitates cluster expansion using a flexible ready node and enhanced join process in accordance with various implementations described herein. System 100 as shown in FIG. 1 includes executable components, e.g., a compatibility checker 110, a node adapter 120, and a node merger 130, each of which can operate as described in further detail below. In an implementation, the components 110, 120, 130 of system 100 can be implemented in hardware, software, or a combination of hardware and software. By way of example, the components 110, 120, 130 can be stored on at least one memory (e.g., a memory 102) and executed by at least one processor (e.g., processor(s) 104). An example of a computer architecture including a processor and memory that can be used to implement the components 110, 120, 130, as well as other components as will be described herein, is shown and described in further detail below with respect to FIG. 16. As further shown in FIG. 1, the executable components 110, 120, 130, the memory 102, the processor 104, and/or other elements of system 100 can communicate with each other via a bus 106 and/or other components that provide intercommunication between various elements of system 100.

Additionally, it is noted that the functionality of the respective components shown and described herein can be implemented via a single computing device and/or a combination of devices. For instance, in various implementations, the compatibility checker 110 shown in FIG. 1 could be implemented via a first device, the node adapter 120 could be implemented via the first device or a second device, and the node merger 130 could be implemented via the first device, the second device, or a third device. Also, or alternatively, the functionality of a single component could be divided among multiple devices in some implementations.

As will be described in further detail below, the components 110, 120, 130 of system 100 can interact with one or more node devices 10 (also referred to herein as “cluster nodes”) of a computing cluster 14 utilizing a clustered file system, one or more node devices 12 (also referred to herein as “joining nodes”) to be merged into the computing cluster 14, and/or other suitable devices. It is noted that the components 110, 120, 130 could themselves be implemented as part of a cluster node 10 and/or joining node 12, or alternatively one or more devices implementing system 100 could be separate from the node device(s) 10, 12 shown in FIG. 1 and communicate with the node device(s) 10, 12 through any suitable wired and/or wireless communication technology(-ies). It is also noted that the node devices 10, 12 shown in system 100 could be physical or virtual devices, depending on implementation.

With reference now to the components of system 100, the compatibility checker 110 can determine compatibility between a first operating system 20, used by cluster nodes 10 associated with the computing cluster 14, with a second operating system 22, used by a joining node 12 to be merged into the computing cluster 14, in response to receiving a request to merge the joining node 12 into the computing cluster 14.

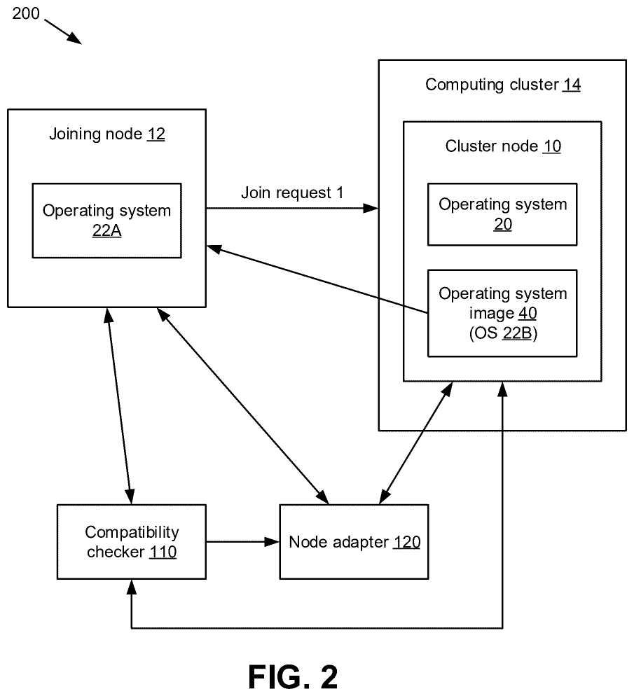

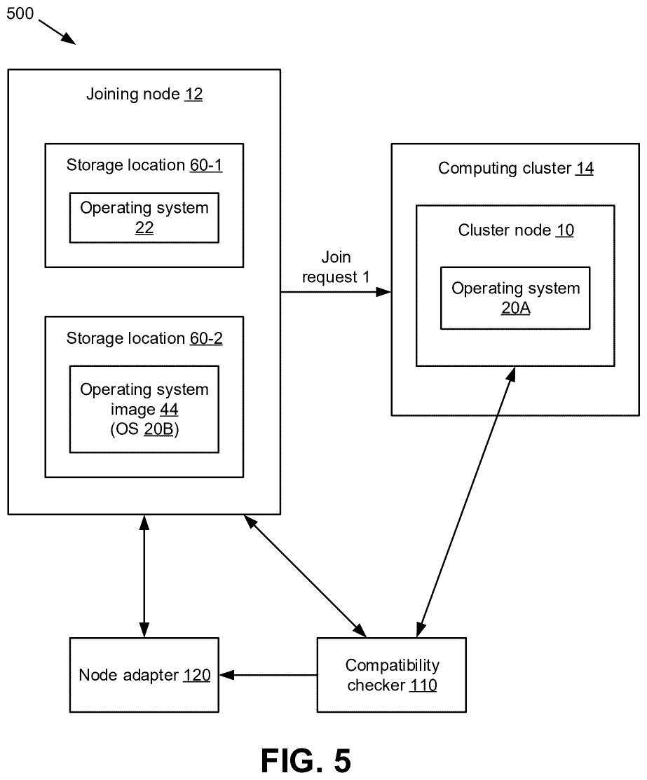

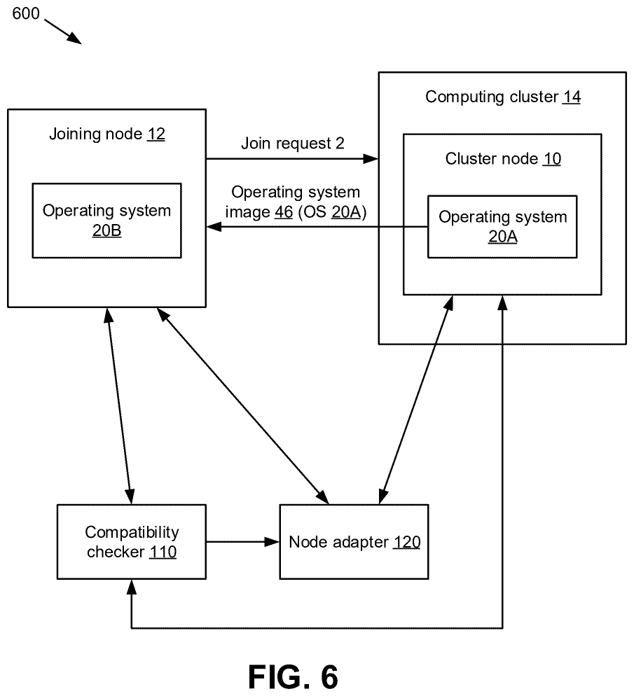

In response to the compatibility checker 110 determining that the operating system 22 of the joining node 12 is incompatible with the operating system 20 associated with the computing cluster 14, the node adapter 120 can cause the joining node 12 to install an operating system image, e.g., an image corresponding to an operating system version that is compatible with the operating system 20 associated with the computing cluster 14. In some implementations, the operating system image can correspond to a version of the operating system 22 utilized by the joining node 12 that is compatible with the operating system 20 associated with the computing cluster 14, as will be described in further detail below with reference to FIGS. 2-4. In other implementations, the operating system image can correspond to a version of the operating system 20 associated with the computing cluster 14, which may be the same as or different from a version of the operating system 20 utilized by cluster nodes 10 of the computing cluster 14, as will be described in further detail below with reference to FIGS. 5-6.

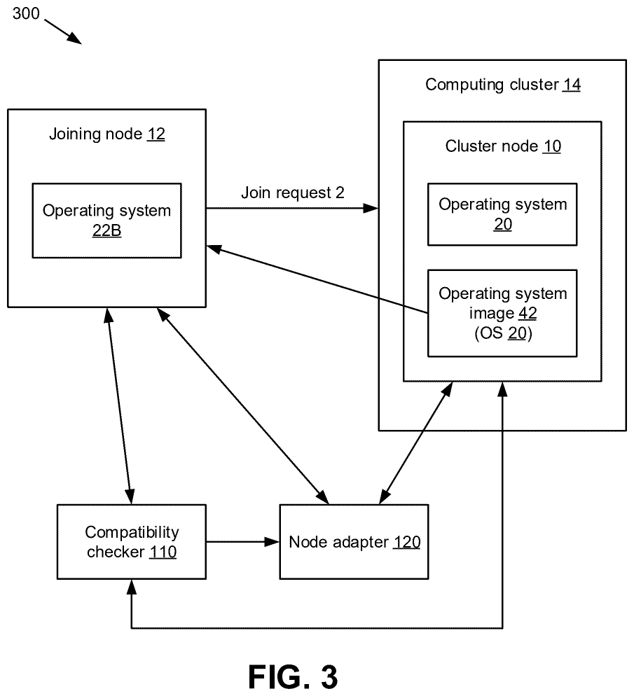

In either of these two cases set forth above, once the joining node 12 has successfully installed, and booted from, the operating system image based on instructions from the node adapter 120, the node merger 130 can facilitate merging the joining node 12 into the computing cluster 14. In some implementations, the node adapter 120 and node merger 130 can perform additional operations before or after merging the joining node 12 into the computing cluster 14 to facilitate converting the joining node 12 to the same operating system 20 used by the computing cluster 14, as will be described in further detail below with reference to FIGS. 3 and 6.

In implementations, an overall solution provided by system 100 can be dependent on what is contained on node devices running a given operating system, e.g., a Linux-based operating system or the like, that are shipped from the factory. The purpose of these nodes can be not only to be able to run their own operating system, but also to be able to host a bootable image and payload of another operating system, e.g., a FreeBSD-based operating system or the like.

As used herein, factory shipped nodes are referred to as “ready nodes” or “factory ready nodes.” In an implementation, a ready node can be a node device that meets the following conditions:
1) By default, the node device boots a first operating system from data drives in the node.
2) On a separate device (e.g., a data drive or an additional drive in the system), a bootable installer of a second, different operating system and an install. tar payload that contains the content of the second operating system that is compatible with the first operating system are present.

Further to this definition, an operating system image that is “compatible” with another operating system is defined as an operating system image that can do the following:
1) A node device, while running the operating system image, can join a cluster running the other operating system and service reads and writes in this state.
2) The operating system image has the content and/or logic to be able to convert a node device running the image, or other node devices, to the other operating system.

As will be described in further detail below, system 100 can be utilized to provide a mechanism to be able to detect the next steps that should be taken for a joining node 12 to join a computing cluster 14 running a different file system and/or operating system, e.g., via enhancements to the cluster join procedure.

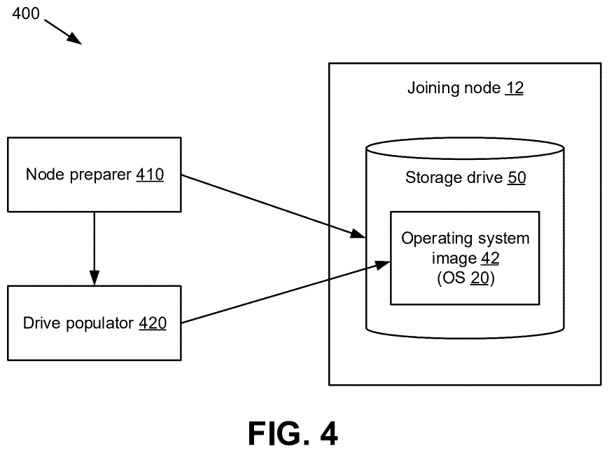

Using the above definitions as a starting point, the following description provides techniques for joining and converting a node device to an operating system utilized by a computing cluster. Various scenarios for joining and conversion are detailed below. For instance, if the joining node 12 is already on a version of a first operating system (e.g., a BSD-based operating system) that is compatible with the operating system of the computing cluster 14 (e.g., a Linux-based operating system), the joining node 12 can skip to the conversion phase, e.g., as described below with reference to FIGS. 3-4. Conversely, if the computing cluster 14 is running an older operating system (e.g., a BSD-based operating system), and the joining node 12 is a ready node that is running a newer operating system (e.g., a Linux-based operating system), the joining node 12 can be regraded to the cluster's operating system to join the cluster, e.g., as will be described below with respect to FIGS. 5-6.

Turning now to system 200 as shown in FIG. 2, another scenario is illustrated in which the computing cluster 14 is associated with a first operating system 20 and the joining node 12 is on a version of a second operating system, denoted in FIG. 2 as operating system 22A, that is not compatible with the first operating system 20. In this case, the joining node 12 can attempt to join the computing cluster 14 running the first operating system 20, e.g., by submitting a first join request to the computing cluster 14. In response to this request, the computing cluster 14 can (e.g., via the compatibility checker 110) determine that (1) the operating system 22A of the joining node 12 is not the same as the operating system 20 of the computing cluster 14, and (2) the version of the operating system 22A running on the joining node 12 is not compatible with the operating system 20 of the computing cluster 14.

Based on the above determination, the node adapter 120 can cause transferal of an operating system image 40, of a second version of the second operating system of the joining node 12, denoted in FIG. 2 as operating system 22B, from a cluster node 10 of the computing cluster 14 to the joining node 12. In an implementation, the operating system image 40 can be stored on one or more cluster nodes 10 as a condition of being factory ready nodes, e.g., based on the definition given above. The joining node 12 can then download the operating system image 40, install it locally, then reboot to the operating system version associated with the operating system image 40, i.e., operating system 22B.

After the joining node 12 has successfully installed, and booted from, the operating system image 40 and is running operating system 22B, the joining node 12 can again attempt to join the computing cluster 14, e.g., by sending a second request to join the computing cluster 14 as shown by system 300 in FIG. 3. At the time that the joining node 12 again attempts to join, the computing cluster 14, e.g., via the compatibility checker 110, can determine that the cluster nodes 10 are running the first operating system 20 and that the joining node 12 is on the compatible version of the second operating system, i.e., operating system 22B. As a result of this determination, the node adapter 120 of system 300 can facilitate transferring relevant portions of the first operating system 20 onto the joining node 12, e.g., in the form of a second operating system image 42.

Turning to FIG. 4, and with further reference to FIG. 3, a system 400 that facilitates transferring the operating system image 42 to the joining node 12 and converting the joining node 12 to the first operating system 20 using the operating system image 42 is shown. System 400 as shown in FIG. 4 includes a node preparer 410 that can prepare the joining node 12 for conversion to the first operating system 20, e.g., by preparing one or more storage drives 50 of the joining node 12 for receiving the operating system image 42. For instance, the node preparer 410 can ensure that the joining node 12 has enough space for the operating system image 42 by looking in the system of the joining node 12 for a storage drive 50 that does not have any mirrored partitions (e.g., BSD-based root0, root1, or other partitions). Once a suitable storage drive 50 is found, the node preparer can clear this storage drive 50 entirely. Because, in this scenario, the joining node 12 is not yet part of the computing cluster 14 and its corresponding file system, the node preparer 410 can, in some implementations, wipe the storage drive 50 without performing data migration or other re-protection actions to move data stored on the storage drive 50 to other storage devices.

In response to the node preparer 410 wiping a storage drive 50 at the joining node 12, the drive populator 420 of system 400 can then transfer data associated with the operating system image 42 to the joining node 12. In an implementation, the operating system image 42 transferred to the joining node 12 by the drive populator 420 can, instead of containing everything from the root partition of the first operating system 20, be a partial image that contains only the contents (e.g., the base operating system, scripts, etc.) required to enable the joining node 12 to boot the installer for the first operating system 20 and re-manufacture itself into a factory ready node, e.g., as described above.

Once the contents of the operating system image 42 have been transferred to the joining node 12, the drive populator 420 can then partition and format the wiped storage drive 50 such that the joining node 12 can boot the installer for the first operating system 20. Once everything has been set up on the joining node 12 by the drive populator 420, the joining node 12 can set its next boot device to that storage drive 50 and boot from the installer.

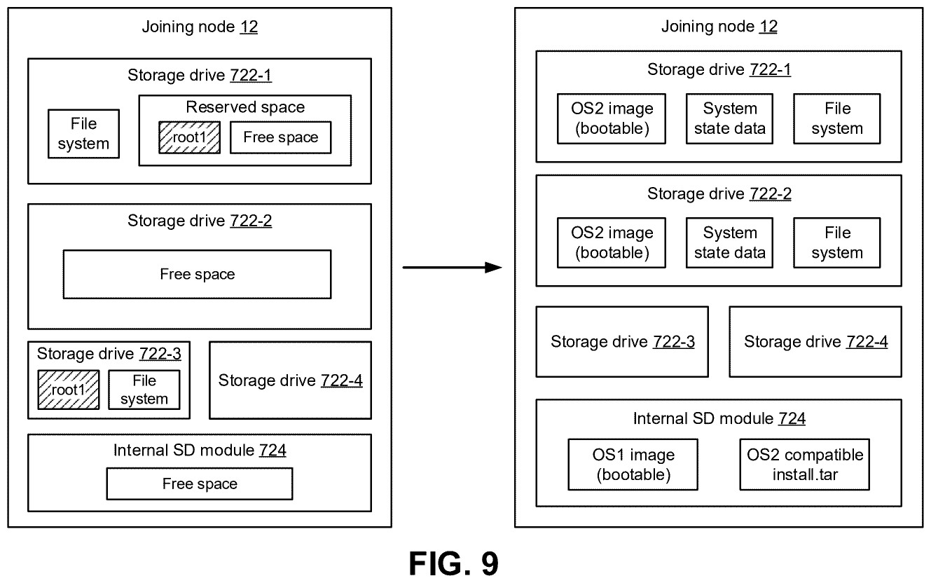

In response to the joining node 12 booting the installer for the first operating system 20, the drive populator 420 can determine that the joining node 12 was previously running the second operating system 22, e.g., based on inspection of the partitions on each of the drives of the joining node 12. Based on this knowledge, the joining node 12 can then re-manufacture itself to appear as a factory ready node. Since all of the data associated with this conversion can be transferred to the joining node 12 at join time, the joining node 12 can partition, format, and/or otherwise set up any storage drives 50 to be able to place itself into the ready node state. As part of converting itself to the ready node state, the joining node 12 can store one or more of the operating system images used during the conversion process, e.g., operating system images 40 and/or 42, at one or more appropriate storage locations of the joining node 12, as will be described in further detail below with reference to FIG. 9. Once the joining node 12 has been successfully converted to the ready node state, the joining node 12 can reboot, and the BIOS (basic input/output system) of the joining node 12 can boot into the first operating system 20.

Returning briefly to FIG. 3, once the joining node 12 is on the first operating system 20, it will again attempt to auto-join the computing cluster 14. This time, since the joining node 12 is now running the first operating system 20, the joining node 12 can simply join and merge with the rest of the computing cluster 14, e.g., via the node merger 130 as described above with reference to FIG. 1.

With reference next to system 500 as shown in FIG. 5, another scenario is illustrated in which the computing cluster 14 is associated with a first version of a first operating system, denoted in FIG. 5 as operating system 20A, the joining node 12 is on a second operating system 22, and operating system 20A as used by the computing cluster 14 is not compatible with the second operating system 22. In this case, the joining node 12 can attempt to join the computing cluster 14 running operating system 20A, e.g., by submitting a first join request to the computing cluster 14. In response to this request, the computing cluster 14 can (e.g., via the compatibility checker 110) determine that (1) the operating system 22 of the joining node 12 is not the same as the operating system 20A of the computing cluster 14, and (2) the version of the operating system 20A running on the computing cluster 14 is not compatible with the operating system 22 of the joining node 12. As a result of this determination, the node adapter 120 can facilitate re-grading the joining node 12 to the first operating system associated with the computing cluster 14, e.g., as follows.

In the example shown by FIG. 5, the joining node 12 is a ready node, meaning that it has the second operating system 22 stored at a first storage location 60-1 (e.g., a storage drive, a secure digital (SD) module, etc.) and an operating system image 44, of a second version of the first operating system (denoted in FIG. 5 as operating system 20B) that is compatible with the second operating system 22, stored at a second storage location 60-2. Accordingly, at join time, the joining node 12 can re-grade to operating system 20B, e.g., via the operating system image 44.

In some implementations, however, the joining node 12 may not be capable of simply reimaging to operating system 20B because the base operating system differs from that of the second operating system 22. In this case, the compatibility checks performed by the compatibility checker 110 in association with the join request will fail, but the joining node 12 can determine, as a result of that failure, that in order to join the computing cluster 14 it needs to convert back to operating system 20B. As a result, the joining node 12 can set its boot device to the storage location 60-2, i.e., the device that contains the operating system image 44, and reboot.

Once booted off the operating system image 44, the joining node 12 can (e.g., via the node adapter 120) wipe out all the partitions on its data drives and recreate partitions associated with operating system 20B and their associated mirrors. Once all mirrors are created, the joining node 12 can use data present on the joining node 12 (which, it is noted, will not match operating system 20A as running on the computing cluster 14). Once operating system 20B has been installed on the joining node 12, the joining node 12 can reboot off its data drives and boot operating system 20B.

During the process of booting the joining node 12 from operating system 20B, the joining node 12 can again attempt to join the computing cluster 14, e.g., by submitting a second request to join the computing cluster 14 as shown by system 600 in FIG. 6. In an implementation, the joining node 12 can attempt to auto-join the computing cluster 14, which can utilize a method of leaving a breadcrumb file behind on the operating system image 44 described above with reference to FIG. 5 to determine the cluster to join. This same breadcrumb file can be reused in the subsequent steps. As a result of the joining node 12 again attempting to join the computing cluster 14, the computing cluster 14 can (e.g., via the compatibility checker 110) determine that the image on the joining node 12 does not match the one on the computing cluster 14. As a result, the computing cluster 14 (e.g., via the node adapter 120) can re-grade the joining node 12, e.g., by directing a cluster node 10 of the computing cluster 14 to transfer another operating system image 46, of the operating system 20A utilized by the computing cluster 14, to the joining node 12. After another reboot into operating system 20A, the joining node 12 can attempt to auto-join again. This time, because the operating systems of the joining node 12 and the computing cluster 14 match, the join will be successful, and the joining node 12 can be merged into the computing cluster 14, e.g., via a node merger 130 as described above with respect to FIG. 1.

With reference again to FIG. 1, implementations described herein can facilitate enhancements to the cluster join process, e.g., such that the join process can detect that a joining node 12 has an incompatible operating system with that of the computing cluster 14 and, as a result, orchestrate a re-grade to a compatible operating system image and convert the joining node to a factory ready node (e.g., that is dual boot capable). By way of a specific, non-limiting example in which the computing cluster 14 is Linux-based and the joining node 12 is running a FreeBSD-based operating system, the computing cluster 14 can determine at join time that the joining node 12 is not Linux-based nor is it on a compatible FreeBSD-based operating system version. In this case, the desired outcome can be a Linux-based node joining the Linux-based cluster. Given this starting point, the join process can orchestrate the installation of a compatible FreeBSD-based operating system version. Once the joining node 12 is booted into this FreeBSD-based version, the join process can orchestrate steps to be completed by the joining node 12 such that it will boot into a Linux installer and remanufacture itself to resemble a factory ready node. At this point, the joining node 12 is capable of dual booting and joining either Linux-based or FreeBSD-based clusters. In the scenario where the joining node 12 is joining a Linux-based cluster, once the joining node 12 is done in the Linux installer, it can boot the Linux-based operating system and be able to join the computing cluster 14.

Additionally, implementations described above can facilitate directing a joining node 12 to boot into an installer such that it can regrade to join and/or merge into a target cluster in some circumstances. For instance, in the two use-case examples described above with reference to FIGS. 2-4 and FIGS. 5-6, respectively, the computing cluster 14 can determine that the image of the joining node 12 is not compatible, e.g., due to the image being of the wrong operating system or an incorrect/incompatible operating system version. At this point, the computing cluster 14 can transfer an image that the joining node 12 can boot into. This can enable the joining node 12 to boot into an installer to prepare the joining node 12 to be able to join the computing cluster 14. Once the installation step is complete, the joining node 12 can boot into the new operating system and then join the computing cluster 14.

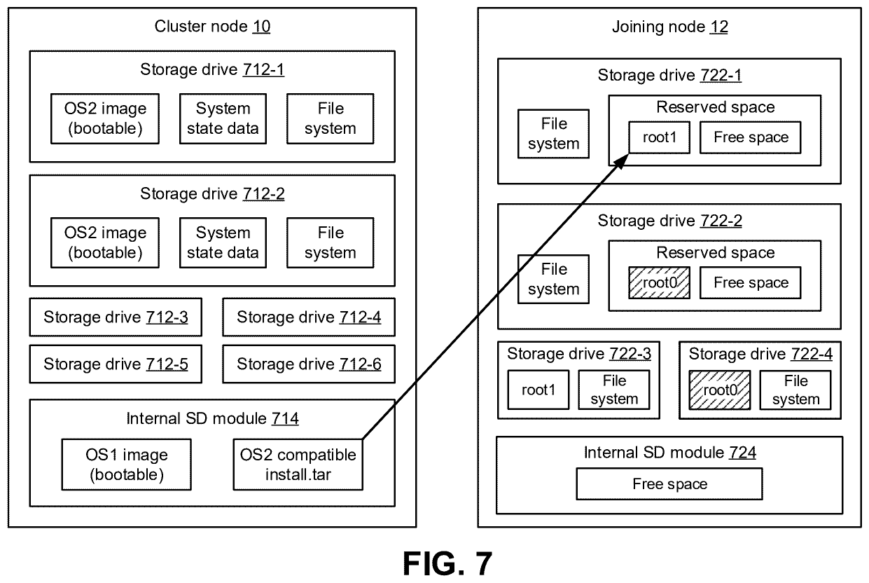

With reference now to FIGS. 7-9, respective steps of a process for adding a joining node 12 running a first operating system, e.g., a FreeBSD-based operating system, to a cluster running a second operating system, e.g., a Linux-based operating system, are illustrated. More particularly, FIGS. 7-9 illustrate respective states of a joining node 12 and a cluster node 10 associated with the target cluster. With regard to FIGS. 7-9, it is noted that the number of storage drives 712, 722 shown with reference to the cluster node 10 and joining node 12, respectively, as well as the contents of those storage drives 712, 722, are intended merely as a non-limiting example of a cluster join process and are not intended to limit any of the description provided herein to any particular type of node device, number of storage drives, or other properties.

Referring first to FIG. 7, an example cluster node 10 and joining node 12 in the initial state of a join process are illustrated. Here, the joining node 12 is running a first operating system (referred to in FIG. 7 as “operating system 1” or OS1), e.g., a FreeBSD-based operating system, and the cluster node 10 is running a second operating system (referred to in FIG. 7 as “operating system 2” or OS2), e.g., a Linux-based operating system. In the example shown by FIG. 7, the version of OS1 used by the joining node 12 includes system partitions, such as system partition root0 and/or other partitions. In this example, it is determined that this version of OS1 is not compatible with OS2 as used by the cluster node 10. As a result, the cluster node 10 can facilitate re-imaging the joining node 12 to a version of OS1 that is compatible with OS2. For instance, as shown by FIG. 7, the cluster node 10 can leverage code to re-grade the joining node 12, e.g., by pulling an install. tar file or other suitable data stored on the cluster node 10, here stored by an internal SD module 714 at the cluster node 10, and using that file to re-grade the joining node 12.

In FIG. 7, a root partition associated with the version of OS1 originally loaded onto the joining node 12 is denoted as root0. As further shown in FIG. 7, the OS2-compatible version of OS1 can be transferred to the joining node 12, and this version will be unpacked into root1. At this stage of the process, the joining node 12 has partitions corresponding to both root0 and root1. The partitions corresponding to root0 are shaded in FIG. 7 to distinguish them from the partitions corresponding to root1 as well as to indicate root0 as the active booting partition at the process stage shown by FIG. 7, e.g., prior to root1 being set as the active boot partition after the joining node 12 loads the install.tar file corresponding to root1.

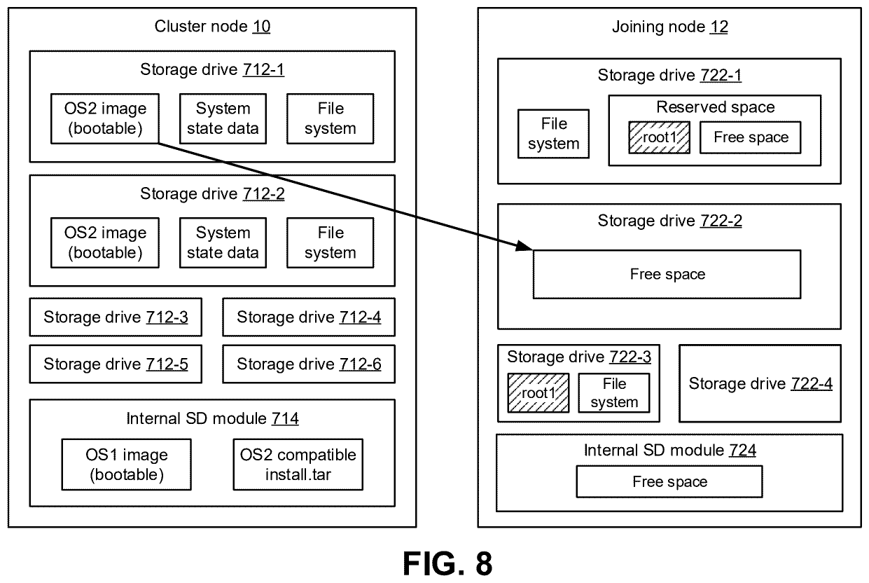

Once the re-grade of the joining node 12 to the OS2-compatible version of OS1 is completed, the joining node 12 can set root1 as the active booting partition, boot from root1, and then try to join the cluster, e.g., as shown by FIG. 8. In the OS2-compatible payload executed by the joining node 12 as shown in FIG. 8, the joining node 12 can detect that it is attempting to join a cluster running OS2. As a result, the joining node 12 can determine that it needs to be able to obtain an OS2 bootable image and create enough free space for it. As shown in FIG. 8, this can be achieved by wiping one or more of the storage drives 722 of the joining node 12, here storage drives 722-2 and 722-4, and then transferring the relevant portions of an OS2 image from the cluster node 10. In an implementation, instead of obtaining a full OS2 image, the joining node 12 can be configured to obtain the portions of OS2 from the cluster node 10 (e.g., the base operating system, scripts, etc.) to re-manufacture the joining node 12 as a ready node.

As shown next by FIG. 9, once the relevant portions of the OS2 image have been copied to the joining node 12, the joining node 12 can reboot into a “thin” version of OS2 that has enough intelligence to convert the joining node 12 into a ready node. The end state of this conversion is a ready node that has a configuration that substantially matches that of the cluster node 10 shown in FIGS. 7-8 and is ready to join the OS2 cluster while running OS2. Once the joining node 12 is in the ready node state as shown by FIG. 9, the cluster can employ one or more mechanisms to auto-join the joining node 12 to the cluster.

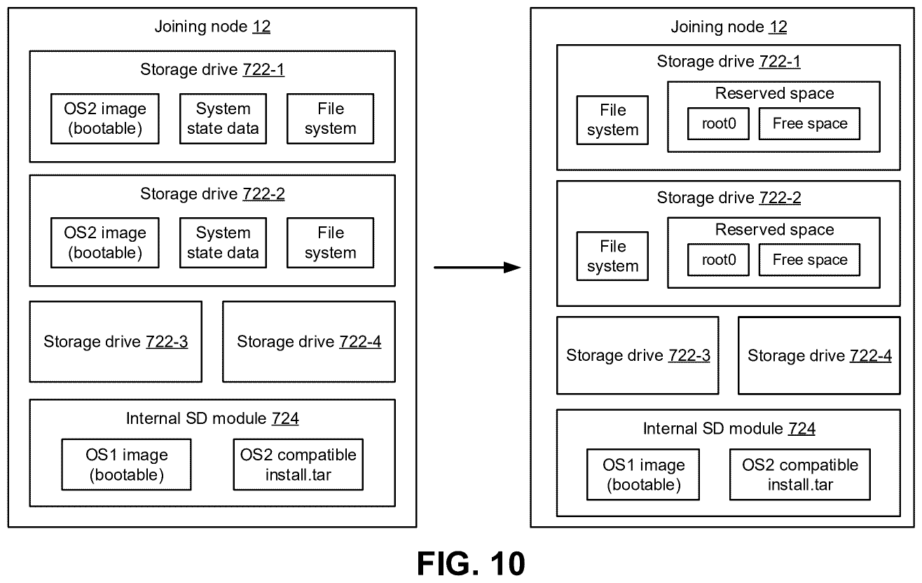

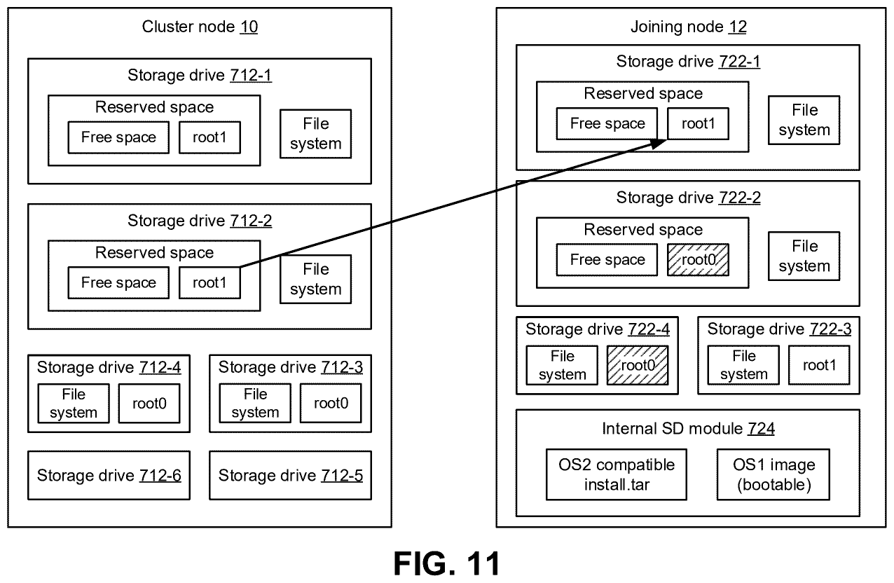

With reference now to FIGS. 10-11, respective steps of a process for adding a joining node 12 running OS2, e.g., a Linux-based operating system, to a cluster of cluster nodes 10 running OS1, e.g., a FreeBSD-based operating system, are illustrated. Similar to FIGS. 7-9, it is noted that the number of storage drives 712, 722 shown with reference to the cluster node 10 and joining node 12, respectively, as well as the contents of those storage drives 712, 722, are intended merely as a non-limiting example of a cluster join process and are not intended to limit any of the description provided herein to any particular type of node device, number of storage drives, or other properties.

Referring first to FIG. 10, the starting point for the join process, as shown by the left side of FIG. 10, is a joining node 12 running OS2 attempting to merge with a cluster running a version of OS1 that is not compatible with OS2. In this case, there can be join checks in place to stop hardware that is not supported by the version of OS1 running on the cluster from joining the cluster. Accordingly, at join time, the joining node 12 can re-grade itself to a version of OS1. Because the joining node 12 shown in FIG. 10 is a ready node, it may in some cases not be possible to simply revert the joining node 12 to OS1. Accordingly, the cluster can inform the joining node 12 that it needs to convert back to OS1. To do this, the joining node 12 can set the next boot device to its internal SD module 724 so that it can boot from an OS1 image stored there.

Once booted from the OS1 image, the joining node 12 can wipe its OS2 partitions, create OS1 partitions and mirrors, and then install the OS2 compatible install. tar file stored on the internal SD module 724. The result of these operations is the storage drives 722-1, 722-2 of the joining node 12 being converted to OS1 use, e.g., as shown via the right side of FIG. 10.

Referring next to FIG. 11, after installing the OS2-compatible version of OS1, the joining node 12 can reboot, e.g., such that the joining node 12 boots from a root0 OS1 partition. At boot, the joining node 12 will try and re-join the cluster, at which time a cluster node 10 of the cluster can re-grade the joining node 12 to the version of OS1 that the cluster is running. Similar to FIG. 7 above, this version of OS1 is denoted in FIG. 11 as root1, and the root0 partitions of the joining node 12 are shown via shading to distinguish them from the root1 partitions. Once the re-grade shown in FIG. 11 has been completed, the joining node 12 can boot from root1 and be able to join the cluster.

It is noted that, in the example process shown by FIGS. 10-11, the contents of the internal SD module 724 of the joining node 12 are not changed. In some implementations, however, the contents of the internal SD module 724 could be overwritten or removed to cause the joining node 12 to more closely resemble a cluster node 10.

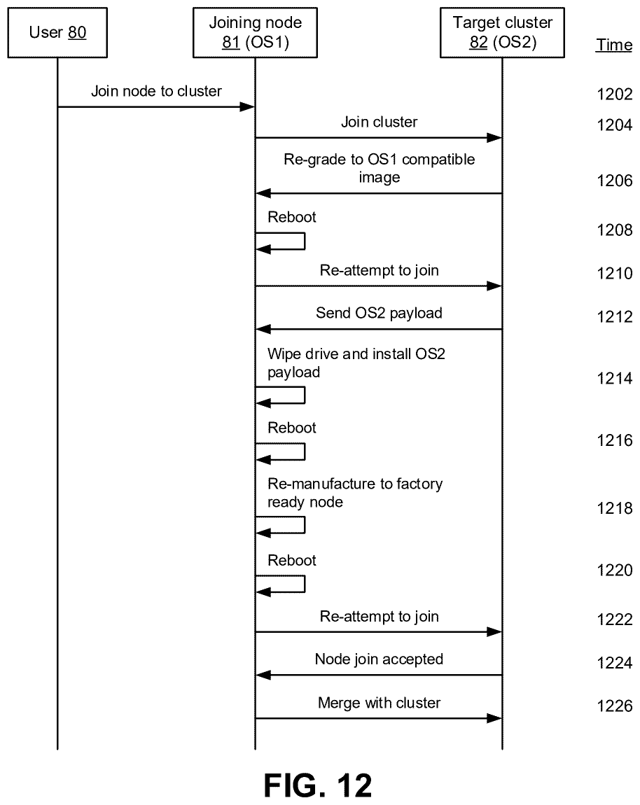

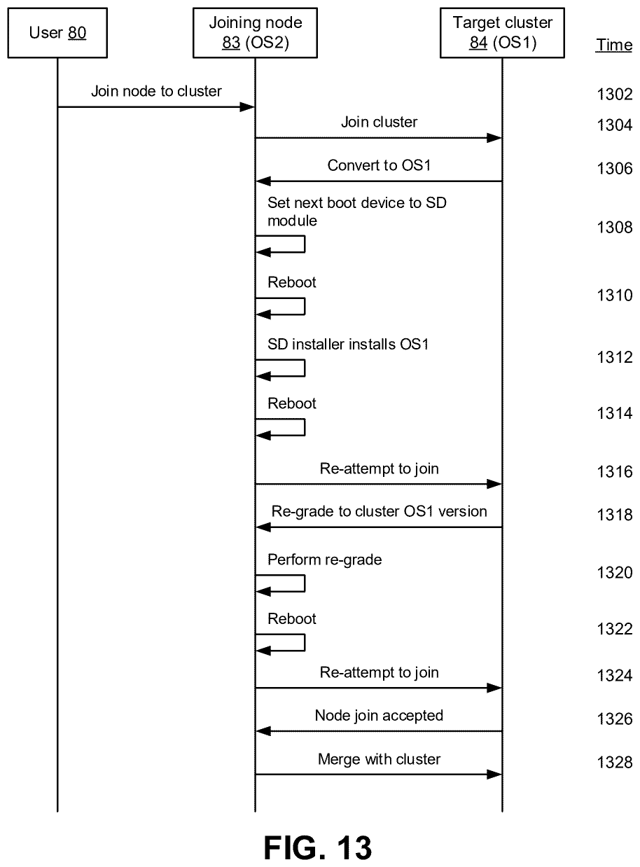

Turning next to FIGS. 12-13, diagrams illustrating respective procedures that can be performed in connection with one or more implementations described herein are illustrated. Referring first to FIG. 12, an example procedure that can be performed to merge a joining node 81 running a first operating system, e.g., OS1 as shown in FIGS. 7-11 above, to a target cluster 82 running a second operating system, e.g., OS2 as shown in FIGS. 7-11 above, where the version of OS1 used by the joining node 81 is not compatible with OS2. The procedure shown by FIG. 12 begins at time 1202, in which a user 80 can initiate merging the joining node 81 into the target cluster 82. The joining node 81 can, in turn, relay a join request to the target cluster 82 at time 1204.

At time 1206, the target cluster 82 can determine that the joining node 81 is not running a version of OS1 that is compatible with OS2 and, as a result, instruct the joining node 81 to re-grade to an OS1-compatible image of OS1. At time 1208, the joining node 81 can re-grade accordingly and reboot from the compatible image.

At time 1210, during or after the joining node 81 boots into the OS2-compatible image of OS1, the joining node 81 can re-attempt to join the target cluster 82. At this time, although the joining node is running a version of OS1 that is compatible with OS2, the target cluster 82 can determine that the joining node 81 should be converted to OS2 before joining the cluster. As a result, at time 1212, the target cluster 82 can send a payload to the joining node 81 that can enable the joining node 81 to convert to OS2.

In response to receiving the OS2 payload, the joining node 81 can, at time 1214, wipe one or more of its drives and install the payload on the newly wiped drive(s). This can be followed by another reboot at time 1216, e.g., to boot into an installer for OS2. After rebooting, the joining node 81 can re-manufacture itself into a factory ready node at time 1218 and then reboot again, e.g., into OS2, at time 1220.

At time 1222, after booting into OS2, the joining node 81 can once again attempt to join the target cluster 82. At time 1224, because the joining node 81 is now running OS2, the target cluster 82 can accept the node join request. As a result, the joining node 81 can then merge with the target cluster 82 at time 1226.

Turning now to FIG. 13, an example procedure that can be performed to merge a joining node 83 running a second operating system, e.g., OS2 as shown in FIGS. 7-11 above, to a target cluster 84 running a first operating system, e.g., OS1 as shown in FIGS. 7-11 above, where the version of OS1 used by the target cluster 84 is not compatible with OS2. The procedure shown by FIG. 13 begins at time 1302, in which a user 80 can initiate merging the joining node 83 into the target cluster 84. The joining node 83 can, in turn, relay a join request to the target cluster 84 at time 1304.

In response to receiving the join request at time 1304, the target cluster 84 can determine that the joining node 83 cannot join the cluster because it is running OS2. As a result, at time 1306, the target cluster 84 can instruct the joining node 83 to convert back to booting OS1. Accordingly, at time 1308, the joining node 83 can set its next boot device to an SD module and/or another storage location at the joining node 83 that contains an installer for OS1. The joining node 83 can then reboot at time 1310, resulting in the joining node 83 now booting from the OS1 installer. At time 1312, the joining node 83 can perform any steps necessary to install OS1, such as re-partitioning, clearing storage locations, etc., and then install OS1. The joining node 83 can then reboot again at time 1314, resulting in the joining node 83 booting from OS1.

Upon rebooting, the joining node 83 can re-attempt to join the target cluster 84 at time 1316. In response, the target cluster 84 can determine that the version of OS1 utilized by the joining node 83 does not match the version used by the cluster. Accordingly, at time 1318, the target cluster 84 can initiate a re-grade of the joining node 83 to the version of OS1 used by the cluster. The joining node can perform this re-grade at time 1320, and then reboot into the version of OS1 used by the cluster at time 1322.

At time 1324, after booting into the version of OS1 used by the target cluster 84, the joining node 83 can once again attempt to join the target cluster 84. At time 1326, because the operating system versions of the joining node 83 and the target cluster 84 match, the target cluster 84 can accept the node join request. As a result, the joining node 83 can then merge with the target cluster 82 at time 1328.

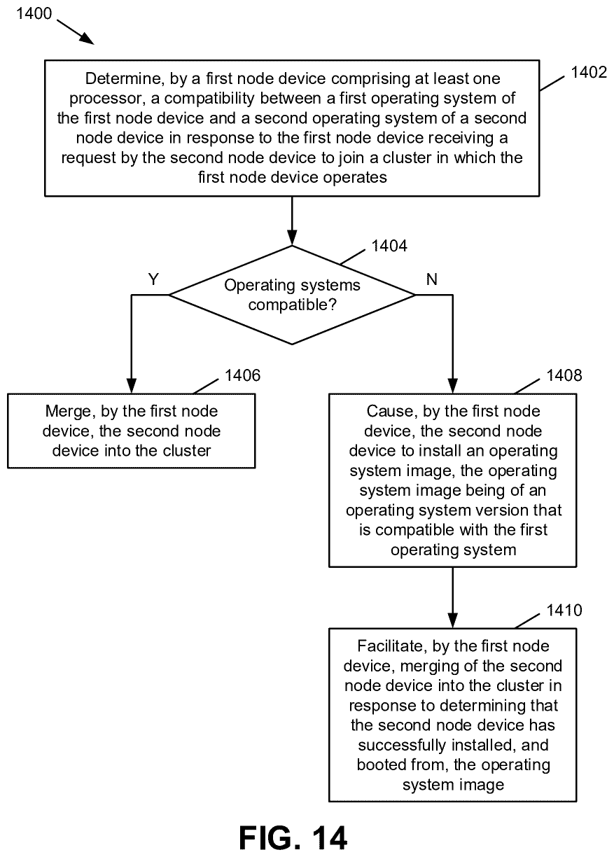

Turning to FIG. 14, a flow diagram of a method 1400 that facilitates cluster expansion using a flexible ready node and enhanced join process is illustrated. At 1402, a first node device (e.g., a cluster node 10) comprising a processor (e.g., a processor 104) can determine (e.g., by a compatibility checker 110) a compatibility between a first operating system of the first node device and a second operating system of a second node device (e.g., a joining node 12) in response to the first node device receiving a request by the second node device to join a cluster (e.g., a computing cluster 14) in which the first node device operates.

At 1404, method 1400 can branch depending on whether the first operating system of the first node device is compatible with the second operating system of the second node device. If the operating systems are compatible, method 1400 can proceed from 1404 to 1406, at which the first node device can merge (e.g., by a node merger 130) the second node device into the cluster.

Alternatively, if the operating systems are not compatible, method 1400 can instead proceed from 1404 to 1408, at which the first node device can cause (e.g., by a node adapter 120) the second node device to install an operating system image. Here, the operating system image can be of an operating system version (e.g., a version of the operating system used by either the first node device or the second node device) that is compatible with the first operating system.

At 1410, the node device can then facilitate (e.g., by the node merger 130) merging of the second node device into the cluster in response to determining that the second node device has successfully installed, and booted from, the operating system image.

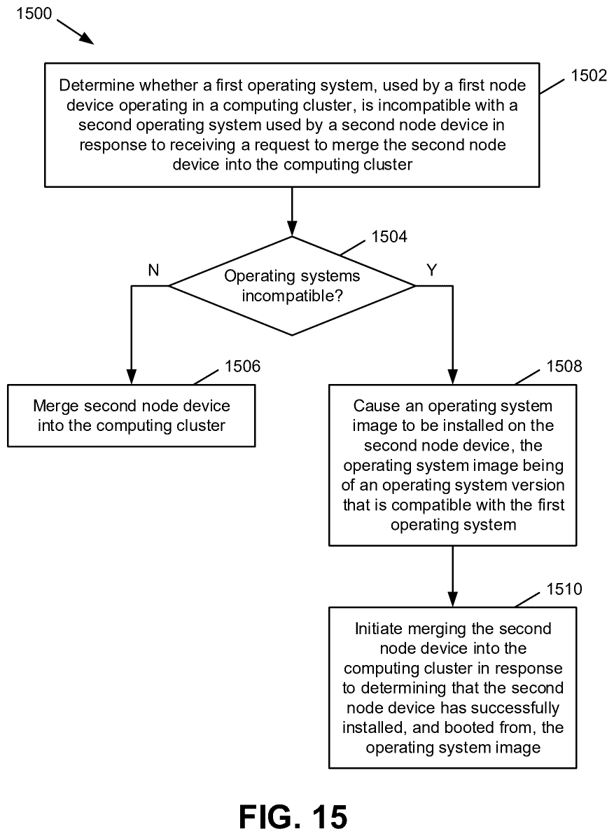

Referring next to FIG. 15, a flow diagram of a method 1500 that can be performed by at least one processor, e.g., based on machine-executable instructions stored on a non-transitory machine-readable medium, is illustrated. An example of a computer architecture, including a processor and non-transitory media, that can be utilized to implement method 1500 is described below with respect to FIG. 16.

Method 1500 can begin at 1502, in which the at least one processor can determine whether a first operating system, used by a first node device operating in a computing cluster, is incompatible with a second operating system used by a second node device in response to receiving a request to merge the second node device into the computing cluster.

At 1504, method 1500 can branch based on the determination made at 1502.

For instance, if the first and second operating systems are not incompatible, method 1500 can proceed from 1504 to 1506, at which the at least one processor can merge the second node device into the computing cluster.

Alternatively, if the if the first and second operating systems are incompatible, method 1500 can proceed from 1504 to 1508, at which the at least one processor can cause an operating system image to be installed on the second node device, the operating system image being of an operating system version that is compatible with the first operating system.

At 1510, the at least one processor can initiate merging the second node device into the computing cluster in response to determining that the second node device has successfully installed, and booted from, the operating system image.

FIGS. 14-15 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 16 and the following discussion are intended to provide a brief, general description of a suitable computing environment 1600 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 16, an example general-purpose environment 1600 for implementing various embodiments described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD), a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
determining compatibility between a first operating system, used by a first computing device, with a second operating system, used by a second computing device, in response to receiving a request to merge the second computing device into a cluster in which the first computing device operates;
in response to determining that the second operating system is incompatible with the first operating system, causing the second computing device to install an operating system image, the operating system image being of an operating system version that is compatible with the first operating system; and
merging the second computing device into the cluster in response to determining that the second computing device has successfully installed, and booted from, the operating system image.

2. The system of claim 1, wherein the second operating system is of a first version, and wherein the operating system image is of a second version of the second operating system.

3. The system of claim 2, wherein the causing of the second computing device to install the operating system image comprises the causing of a transferal of the operating system image from the first computing device to the second computing device.

4. The system of claim 2, wherein the request to merge the second computing device into the cluster is a first request, wherein the operating system image is a first operating system image, and wherein the merging comprises:
in response to receiving, after the second computing device has successfully installed, and booted from, the first operating system image, a second request to merge the second computing device into the cluster, transferring a second operating system image, of the first operating system, to the second computing device, and
merging the second computing device into the cluster in response to determining that the second computing device has successfully installed, and booted from, the second operating system image.

5. The system of claim 4, wherein the merging further comprises:
in further response to receiving the second request, clearing a storage device of the second computing device, and
installing the second operating system image on the storage device.

6. The system of claim 4, wherein the operations further comprise:
in response to the second computing device being merged into the cluster, storing the first operating system image at the second computing device.

7. The system of claim 1, wherein the first operating system is of a first version, and wherein the operating system image is of a second version of the first operating system.

8. The system of claim 7, wherein the second operating system is stored on a first storage device of the second computing device, and wherein the operating system image is stored on a second storage device of the second computing device.

9. The system of claim 7, wherein the request to merge the second computing device into the cluster is a first request, wherein the operating system image is a first operating system image, and wherein the merging comprises:
in response to receiving, after the second computing device has successfully installed, and booted from, the first operating system image, a second request to merge the second computing device into the cluster, transferring a second operating system image, of the first version of the first operating system, to the second computing device, and
merging the second computing device into the cluster in response to determining that the second computing device has successfully installed, and booted from, the second operating system image.

10. A method, comprising:
determining, by a first node device comprising at least one processor, a compatibility between a first operating system of the first node device and a second operating system of a second node device in response to the first node device receiving a request by the second node device to join a cluster in which the first node device operates;
in response to determining that the second operating system does not have the compatibility with the first operating system, causing, by the first node device, the second node device to install an operating system image, the operating system image being of an operating system version that is compatible with the first operating system; and
facilitating, by the first node device, merging of the second node device into the cluster in response to determining that the second node device has successfully installed, and booted from, the operating system image.

11. The method of claim 10, wherein the second operating system is of a first version, and wherein the operating system image is of a second version of the second operating system.

12. The method of claim 11, wherein the causing of the second node device to install the operating system image comprises facilitating a transferal of the operating system image from the first node device to the second node device.

13. The method of claim 11, wherein the request is a first request, wherein the operating system image is a first operating system image, and wherein the facilitating of the merging comprises:
in response to receiving, after the second node device has successfully installed, and booted from, the first operating system image, a second request from the second node device to join the cluster, facilitating a transferal of a second operating system image, of the first operating system, to the second node device, and
merging the second node device into the cluster in response to determining that the second node device has successfully installed, and booted from, the second operating system image.

14. The method of claim 10, wherein the first operating system is of a first version, and wherein the operating system image is of a second version of the first operating system.

15. The method of claim 14, wherein the request is a first request, wherein the operating system image is a first operating system image, and wherein the facilitating of the merging comprises:
in response to receiving, after the second node device has successfully installed, and booted from, the first operating system image, a second request from the second node device to join the cluster, facilitating transferal of a second operating system image, of the first version of the first operating system, to the second node device, and
facilitating the merging of the second node device into the cluster in response to determining that the second node device has successfully installed, and booted from, the second operating system image.

16. A non-transitory machine-readable medium comprising computer executable instructions that, when executed by at least one processor, facilitate performance of operations, the operations comprising:
determining whether a first operating system, used by a first node device operating in a computing cluster, is incompatible with a second operating system used by a second node device in response to receiving a request to merge the second node device into the computing cluster;
in response to determining that the first operating system is incompatible with the second operating system, causing an operating system image to be installed on the second node device, the operating system image being of an operating system version that is compatible with the first operating system; and
initiating merging the second node device into the computing cluster in response to determining that the second node device has successfully installed, and booted from, the operating system image.

17. The non-transitory machine-readable medium of claim 16, wherein the second operating system is of a first version, and wherein the operating system image is of a second version of the second operating system.

18. The non-transitory machine-readable medium of claim 17, wherein the request is a first request, wherein the operating system image is a first operating system image, and wherein the initiating of the merging comprises:
in response to receiving, after the second node device has successfully installed, and booted from, the first operating system image, a second request to merge the second node device into the computing cluster, initiating a transferal of a second operating system image, of the first operating system, to the second node device, and
initiating the merging of the second node device into the computing cluster in response to determining that the second node device has successfully installed, and booted from, the second operating system image.

19. The non-transitory machine-readable medium of claim 16, wherein the first operating system is of a first version, and wherein the operating system image is of a second version of the first operating system.

20. The non-transitory machine-readable medium of claim 19, wherein the request is a first request, wherein the operating system image is a first operating system image, and wherein the initiating of the merging comprises:
in response to receiving, after the second node device has successfully installed, and booted from, the first operating system image, a second request to merge the second node device into the computing cluster, initiating a transferal of a second operating system image, of the first version of the first operating system, to the second node device, and
merging the second node device into the computing cluster in response to determining that the second node device has successfully installed, and booted from, the second operating system image.
